(19) United States
(12) Patent Application Publication
(10) Pub. No.: US 2024/0187831 A1
(43) Pub. Date: Jun. 6, 2024

(54) DRIVE-BY CONNECTIVITY NETWORK

(71) Applicant: Wavelnnova Inc., Mountain View, CA (US)

(72) Inventors: Anubhav Gupta, Mountain View, CA (US); Anup Savla, Mountain View, CA (US)

(21) Appl. No.: 18/061,494

(22) Filed: Dec. 5, 2022

(51) Int. Cl. H04W 4/80; H04W 4/38

(52) U.S. Cl. CPC H04W 4/80; H04W 4/38

(57) ABSTRACT

The present disclosure provides systems, devices, and methods for creating a worldwide network of low-power, wireless devices using drive-by connectivity gateways. An example system may comprise: a device comprising a sensor and a first short-range communication module that is configured to use a short-range communication standard; and a plurality of gateways disposed on a plurality of moving vehicles, wherein each gateway comprises (i) a second short-range communication module that is configured to use the short-range communication standard and a (ii) long-range communication module, wherein the first short-range communication module is in intermittent wireless communication with one or more second short-range communication modules of one or more gateways of the plurality of gateways, and wherein during the intermittent wireless communication, the first short-range communication module is configured to transmit data from the sensor to the one or more second short-range communication modules.

### BACKGROUND

Wireless devices may consume significant power when transmitting data to remote locations (e.g., to cellular network towers).

### SUMMARY

The present disclosure provides systems, devices, and methods for creating a worldwide network of low-power, wireless devices (e.g., Internet-of-Things sensors) using drive-by connectivity gateways. A low-power, wireless device can intermittently connect to gateways on moving vehicles over short-range communication networks (e.g., Wi-Fi, Bluetooth, or Zigbee networks) when the vehicles in the vicinity of the wireless device. During the periods of intermittent connectivity, the wireless device can transmit data to the gateways. The gateways can then transmit the data to a remote location over a long-range communication network (e.g., a cellular network).

The network described above provides numerous advantages. First, the wireless devices need not have long-range communication modules or transmit data over long-range communication networks. This may reduce the power consumption of the wireless devices significantly (the power consumption of the wireless devices during sensing and processing may be insignificant compared to their power consumption during transmission). Second, due to their low power consumption, the wireless devices may have smaller batteries than normal. And third, by using mobile gateways, the network described above need not have fixed gateways in particular locations. This may reduce overall infrastructure costs and increase the coverage area of the gateways.

In an aspect, the present disclosure comprises a system. The system may comprise a device comprising a sensor and a first short-range communication module that is configured to use a short-range communication standard; and a plurality of gateways disposed on a plurality of moving vehicles, wherein each gateway comprises (i) a second short-range communication module that is configured to use the short-range communication standard and a (ii) long-range communication module, wherein the first short-range communication module is in intermittent wireless communication with one or more second short-range communication modules of one or more gateways of the plurality of gateways, and wherein during the intermittent wireless communication, the first short-range communication module is configured to transmit data from the sensor to the one or more second short-range communication modules.

In some embodiments, the intermittent wireless communication lasts for at most 5 seconds at a time. In some embodiments, the device is an Internet-of-Things device. In some embodiments, the device comprises an energy harvesting circuit. In some embodiments, the device comprises a battery. In some embodiments, the device is not connected to an external power source. In some embodiments, the device does not comprise a long-range communication module. In some embodiments, the short-range communication standard is Wi-Fi, Bluetooth, or Zigbee. In some embodiments, the long-range communication module comprises a cellular antenna. In some embodiments, the first short-range communication module comprises a low-power processor for detecting a signal from the second short-range communication device. In some embodiments, the low-power processor is configured to establish the wireless communication between the first short-range communication module and the second short-range communication module. In some embodiments, the low-power processor is configured to wake up the device.

Another aspect of the present disclosure provides methods for establishing wireless communication between the first short-range communication module and the second short-range communication module.

Another aspect of the present disclosure provides a non-transitory computer readable medium comprising machine executable code that, upon execution by one or more computer processors, implements any of the methods described above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates a low-power, wireless device network, according to some embodiments of the present disclosure;

FIG. 2 illustrates a flow chart of a process 200 for establishing drive-by connectivity network.

FIG. 3 illustrates a flow chart of a process 300 for establishing drive-by connectivity network.

FIG. 4 illustrates a computer system that is programmed or otherwise configured to implement the systems methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

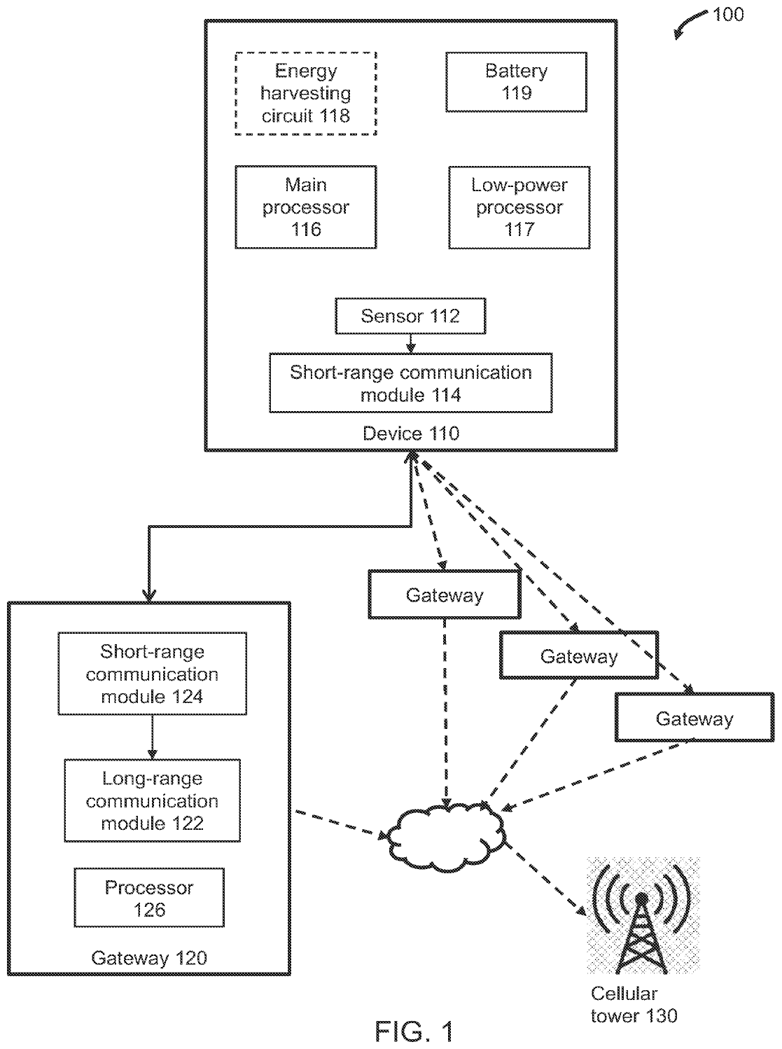

FIG. 1 schematically illustrates low-power, wireless device network 100, according to some embodiments of the present disclosure. The network 100 may have wireless devices 110, mobile gateways 120, and cellular towers 130.

The wireless devices 110 may be stationary. In some embodiments, the wireless devices 110 may be non-stationary. The wireless devices 100 may be Internet-of-Things (IoT) sensors. Each wireless device 100 may have one or more sensors 112, one or more main processors 116, one or more low-power processors 117, an energy harvesting circuit 118, a battery 119, and a short-range communication module 114. The sensors 112 may be traffic sensors, environmental sensors, or the like. In some embodiments, the sensors 112 may be temperature sensors, humidity sensors, pressure sensors, altitude sensors, accelerometers, infrared sensors, optical sensors, or the like. In some other embodiments, the sensors 112 may be biometric sensors, such as fingerprint recognition sensor, face recognition sensor, iris recognition sensor, voice recognition sensor, and the like. The main processors 116 may be a single core or multi core processor, or a plurality of processors for parallel processing. The battery 119 may be rechargeable battery, such as lead-acid battery, NiCd battery, NiFe battery, NiMH battery, lithium-ion battery, lithium-ion polymer battery, and the like. Alternatively or additionally, the wireless devices 110 may include an energy harvesting circuit 118 (e.g., solar modules, thermoelectric generators, or the like). The energy harvesting circuit 118 may harvest electricity and charge the battery 118 as needed. The energy harvesting circuit 118 may harvest energy from solar power according to one embodiment. The energy harvesting circuit 118 may harvest energy via movement, for example, a smart watch (e.g., a wireless device) may be equipped with an energy harvesting circuit to power the watch by the movements. The wireless devices 110 may or may not be connected to external power sources. The short-range communication modules 114 may have receivers and transmitters. In some embodiments, the short-range communication modules 114 may receive data from the sensors 112 and transmit the data to other devices over short-range communication networks. The short-range communication modules 114 may be configured to establish wireless communication with other devices over short-range communication networks using short-range communication standards. In some embodiments, the short-range communication modules 114 may have a data storage storing data received from the sensors 112 and transfer the data once a wireless communication is established. In some other embodiments, the sensors 112 may have a data storage, and once a wireless communication between the short-range communication modules 114 and other devices is established, the short-range communication modules 114 may retrieve data from the data storage of the sensor 112 and then transfer the data to other devices. The short-range communication standards may be any communication standards that establishes a wireless communication wherein signals travel from a few centimeters to several meters. In some embodiments, the short-range wireless standard may allow signals to travel less than about 100 meters, 90 meters, 80 meters, 70 meters, 60 meters, 50 meters, 40 meters, 30 meters, 20 meters, 10 meters, 5 meters, 4 meters, 3 meters, 2 meters, 1 meters, 90 centimeters, 80 centimeters, 70 centimeters, 60 centimeters, 50 centimeters, 40 centimeters, 30 centimeters, 20 centimeters, 10 centimeters, 5 centimeters, 4 centimeters, 3 centimeters, 2 centimeters, 1 centimeters, or less. In some cases, the wireless communication may last greater than 100 meters. The short-range wireless standard may be Wi-Fi, Bluetooth, Zigbee, Near-Field Communications, Radio-Frequency Identification (RFID), Infrared Wireless, or the like. The short-range communication modules 114 may establish a wireless communication to transfer data at a very low power-consumption rate. Although short-range communication standards are used here as examples to establish a wireless communication, the short-range communication modules 114 may use other communication standards to establish low power-consumption wireless communication. For example, some cellular radio may also provide data transmission capability for machine-to-machine (M2M) applications in a short-range communication networks. The short-range communication standards, according to the present disclosure, may transmit data at a very low power-consumption rate, regardless what particular standard actually used herein. The wireless devices 110 may not have long-range communication modules (e.g., a communication module with a cellular antenna). In some embodiments, the wireless devices 110 may optionally have long-range communication modules that are mostly in idle, as a backup communication module. The long-range communication modules of the wireless devices 110 may only operate to transfer data when a period of time since the last data transfer has lapse, such as 2 day, 5 days, or one month. The wireless devices 110 may have a low-power processor 117. The low-power processor 117 may detect signals from other short-range communication modules and establish a wireless communication between the short-range communication modules 114 of the wireless device 110 and the detected other short-range communication modules. In some embodiments, the low-power processor 117 may be configured to wake up the wireless device 110.

The mobile gateways 120 may be disposed on vehicles (e.g., cars, busses, trains, etc.). Each mobile gateway 120 may have one or more processors 126, a short-range communication module 124, and a long-range communication module 122. The short-range communication modules 124 of the mobile gateways 120 may be substantially similar to the short-range communication modules 114 of the wireless devices 110. The long-range communication modules may have cellular antennas or the like.

When a particular mobile gateway 120 is in the vicinity of a wireless device 110, the short-range communication module 124 of the mobile gateway 120 can establish wireless communication with the short-range communication module 114 of the wireless device 110. To establish wireless communication, the gateway 120 can continuously or periodically transmit a pairing signal. A low-power processor 117 in the wireless device 110 can detect and authenticate the pairing signal and wake up the wireless device 110 so that a communication channel can be established. In some cases, the wireless communication may last less than about 5 seconds, 4 seconds, 3 seconds, 2 seconds, 1 second, 900 milliseconds, 800 milliseconds, 700 milliseconds, 600 milliseconds, 500 milliseconds, 400 milliseconds, 300 milliseconds, 200 millisecond, 100 milliseconds, or less. In some cases, the wireless communication may last greater than 5 seconds. During the period of wireless communication, the wireless device 110 can transmit data (e.g., data from one of its sensors) to the mobile gateway 120. Thereafter, the mobile gateway 120 can transmit the data to the cellular tower 130.

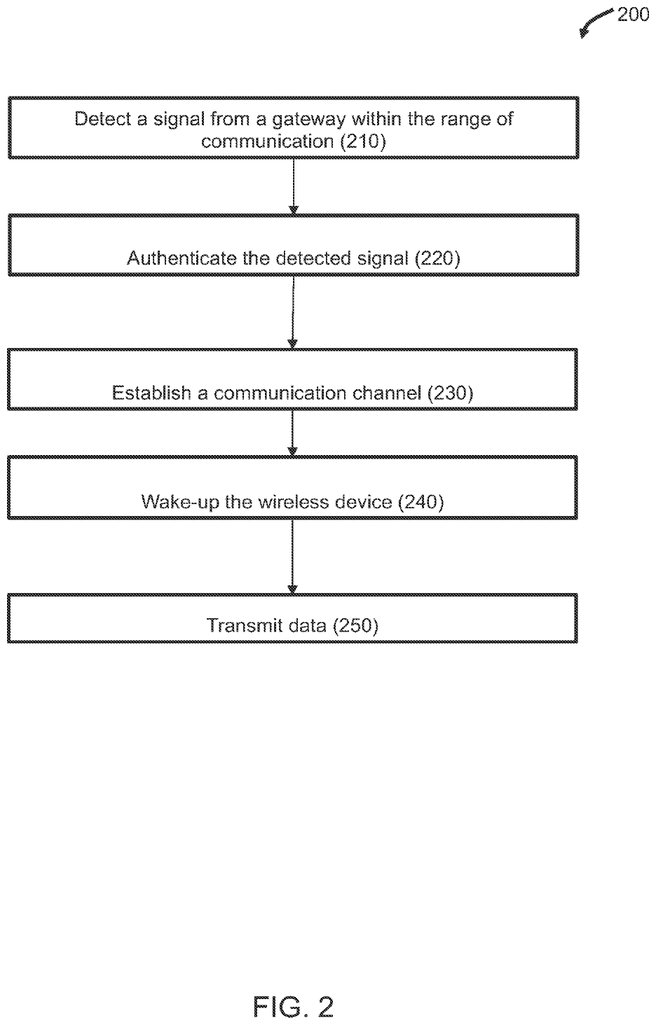

FIG. 2 is a flow chart of a process 200 for establishing drive-by connectivity network. The process 200 can be performed by a low-power, wireless device network (e.g., device network 100 of FIG. 1).

In an operation 210, a wireless device (e.g., one or more wireless device 110 of FIG. 1) can detect a signal from a gateway (e.g., one or more gateways 120 of FIG. 1). In some embodiments, the signal may be a broadcast signal sent by the gateways continuously or periodically. Any wireless devices within the range of communication (e.g., based on the wireless protocol that is used) may detect the signal. The wireless device may have a low-power processor that is configured to detect the signals when one or more gateways are within the range of communication of the wireless device. In some embodiments, the low-power processor 117 of device 110 of FIG. 1 is constantly detecting signals while the rest of the device is in a sleeping mode. Therefore, the power consumption of the wireless device may maintain low.

In some embodiments, the low-power processor 117 of the wireless device 100 may detect more than one signals from multiple gateways at a time, and a predetermined rule may be adopted to select one of the signals to establish a communication channel. The predetermined rule may allow the wireless device 110 to select one of the following signals: the signal from the nearest gateway, the signal with the fastest transmission speed, the signal with or without a transmission time limit, or the signal with a flexible communication distance, or a combination thereof.

In an operation 220, a wireless device (e.g., one or more wireless device 110 of FIG. 1) can authenticate the detected signal (in some embodiments, the selected signal from multiple detected signals). In some embodiments, the wireless device may check whether a secure identifier is provided along with the detected signal. The wireless device may perform this authentication operation by comparing the secure identifier with an index of authentication secure identifiers stored locally. The global drive-by connectivity network as described by the present disclosure may maintain an index or a list of authentication secure identifiers what each associated with an authenticated gateway. When a new gateway joins the global drive-by connectivity network, the authentication secure identifier may be added to the index of authentication secure identifiers. In some embodiments, this index may be transmitted to the wireless devices and then stored locally for future use. In some embodiments, this index may be automatically updated and transmitted to the wireless devices when a communication channel is established between the wireless devices and a gateway. In some other embodiments, the authentication may be performed by other mechanisms which are able to prevent spoofing.

In an operation 230, a wireless device (e.g., one or more wireless device 110 of FIG. 1) can establish a communication channel between a gateway and the wireless device itself. Various types of communication channels may be established between the gateway and the wireless device depends on the communication protocol the drive-by connectivity network is using. The wireless channels may have different frequencies, effective wireless ranges, and data spends. In some embodiments, the communication channels are short-range communication channels that have a low power-consumption rate.

In an operation 240, a low-power processor (e.g., the low-power processor 117 of FIG. 1) of a wireless device (e.g., one or more wireless device 110 of FIG. 1) can wake-up the wireless device. In some embodiments, the rest of the wireless device other than the low-power processor is in sleeping mode when there is no communication channel established. When a communication channel is established (e.g., via the operation 230), the low-power processor 117 may wake-up the rest of the wireless device. In some other embodiments, the rest of the wireless device other than the low-power processor and the sensors is in sleeping mode when there is no communication channel established. In this case, the sensors may sense and accumulate data while the rest of the wireless device is in sleeping mode. Similarly, when a communication channel is established, the low-power processor 117 may wake-up the rest of the wireless device.

In an operation 250, a wireless device (e.g., one or more wireless device 110 of FIG. 1) can transmit data via the established communication channel to a gateway (e.g., one or more gateways 120 of FIG. 1). In some embodiments, the transmission of data is bidirectional between the gateway and the wireless device. Via the established short-range communication channel, the wireless device may transmit data in a low power-consumption rate. In some embodiments, the wireless communication may last less than about 5 seconds, 4 seconds, 3 seconds, 2 seconds, 1 second, 900 milliseconds, 800 milliseconds, 700 milliseconds, 600 milliseconds, 500 milliseconds, 400 milliseconds, 300 milliseconds, 200 millisecond, 100 milliseconds, or less.

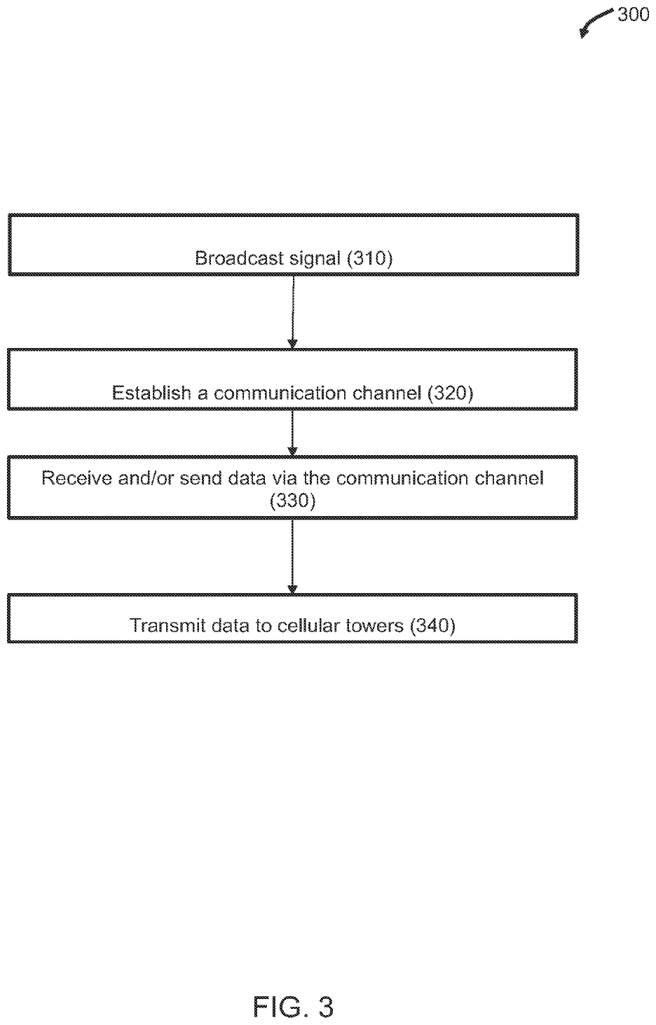

FIG. 3 is a flow chart of a process 300 for establishing drive-by connectivity network. The process 300 can be performed by a low-power, wireless device network (e.g., device network 100 of FIG. 1).

In an operation 310, a gateway (e.g., one or more gateways 120 of FIG. 1) can broadcast signal. This broadcasted signal may be detected by wireless devices (e.g., one or more wireless devices 110 of FIG. 1) when the gateway broadcasting the signal is within the effective wireless range of the wireless devices. In some embodiments, the gateway may be disposed on moving vehicles. When a moving vehicle carrying a gateway is within the effective wireless range of the wireless devices, the wireless device may detect the signal broadcasted by the moving vehicle.

In an operation 320, the gateway 120 can establish a communication channel with the wireless device. When the wireless device 110 detects the broadcasted signal from a gateway, the low-power processor 117 of the wireless device 110 may establish the communication channel with the gateway.

In an operation 330, the gateway 120 can receive and/or send data via the communication channel. In some embodiments, the gateway 120 may send a synchronization signal to the wireless device, and receive an acknowledgement signal (Ack. signal). The gateway 120 may receive data collected by the sensors 112 from the wireless device 110. In some embodiments, the gateway 120 may send an index or a list of authentication secure identifiers what each associated with an authenticated gateway to the wireless device 110. In some embodiments, the wireless communication may last less than about 5 seconds, 4 seconds, 3 seconds, 2 seconds, 1 second, 900 milliseconds, 800 milliseconds, 700 milliseconds, 600 milliseconds, 500 milliseconds, 400 milliseconds, 300 milliseconds, 200 millisecond, 100 milliseconds, or less.

In an operation 340, the gateway 120 can transmit the received data to cellular towers 130. In some embodiments, the gateways 120 deposited on the moving vehicles may have better access to power source, such as being powered by the vehicle. Generally, the transmission from the gateways 120 to the cellular towers 130 may involve long-range transmission, which may be accomplished by a long-range communication module of the gateway (e.g., long-range communication module 112 of FIG. 1).

### Computer Systems

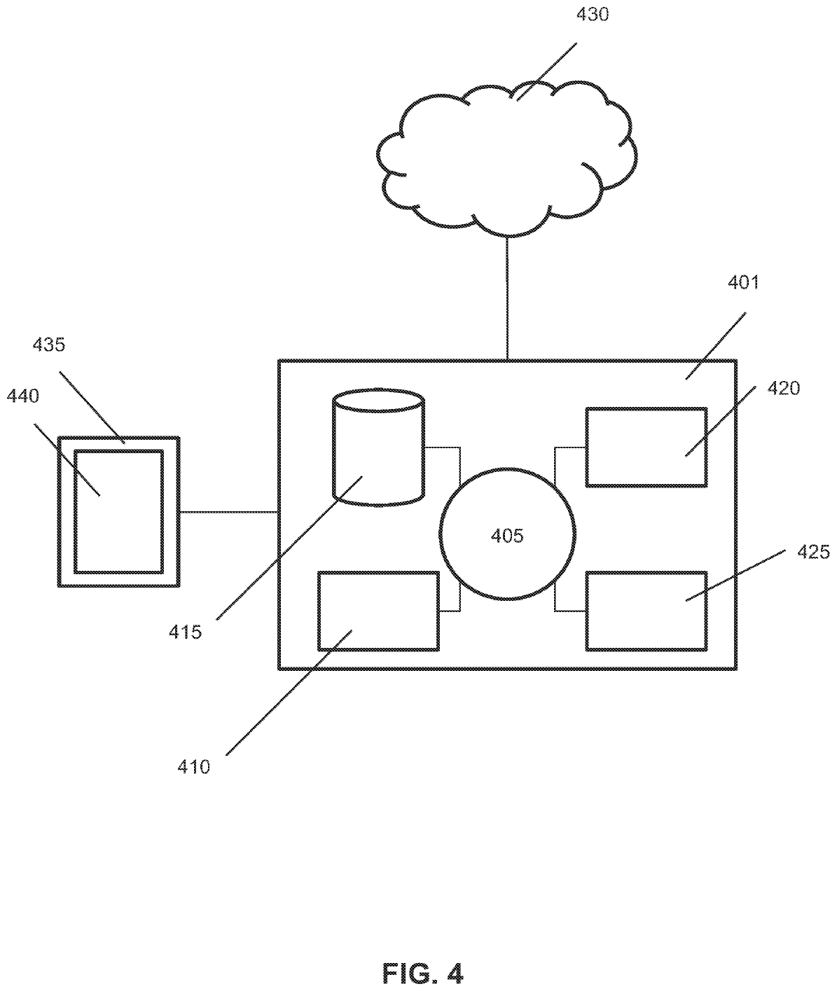

The present disclosure provides computer systems that are programmed to implement methods of the disclosure. FIG. 4 shows a computer system 401 that is programmed or otherwise configured to establish short-range, short-term wireless communication between a wireless device and a gateway. The computer system may be implemented in a mobile gateway or a wireless device.

The computer system 401 includes a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 225, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are external to the computer system 401, such as located on a remote server that is in communication with the computer system 401 through an intranet or the Internet.

The computer system 401 can communicate with one or more remote computer systems through the network 430. For instance, the computer system 401 can communicate with a mobile gateway or a wireless device (e.g., of FIG. 1). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 401 via the network 430.

Methods as described herein can be implemented by way of machine (e.g., computer processor) executable code stored on an electronic storage location of the computer system 401, such as, for example, on the memory 410 or electronic storage unit 415. The machine executable or machine-readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 405.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A system, comprising:
a device comprising a sensor and a first short-range communication module that is configured to use a short-range communication standard; and
a plurality of gateways disposed on a plurality of moving vehicles, wherein each gateway comprises (i) a second short-range communication module that is configured to use said short-range communication standard and a (ii) long-range communication module,
wherein said first short-range communication module is in intermittent wireless communication with one or more second short-range communication modules of one or more gateways of said plurality of gateways, and wherein during said intermittent wireless communication, said first short-range communication module is configured to transmit data from said sensor to said one or more second short-range communication modules.

2. The system of claim 1, wherein said intermittent wireless communication lasts for at most 5 seconds at a time.

3. The system of claim 1, wherein said device is an Internet-of-Things device.

4. The system of claim 1, wherein said device comprises an energy harvesting circuit.

5. The system of claim 1, wherein said device comprises a battery.

6. The system of claim 5, wherein said device is not connected to an external power source.

7. The system of claim 1, wherein said device does not comprise a long-range communication module.

8. The system of claim 1, wherein said short-range communication standard is Wi-Fi, Bluetooth, or Zigbee.

9. The system of claim 1, wherein said long-range communication module comprises a cellular antenna.

10. The system of claim 1, wherein said first short-range communication module comprises a low-power processor for detecting a signal from said second short-range communication module.

11. The system of claim 10, wherein said low-power processor is configured to establish said wireless communication between said first short-range communication module and said second short-range communication module.

12. The system of claim 11, wherein said low-power processor is configured to wake up said device.

13. A method for establishing short-range communication channels for a wireless device, comprising:
detecting a signal from a gateway from a plurality of gateways within a range of communication, wherein the plurality of gateways is deposited on a plurality of moving vehicles;
establishing a communication channel between the wireless device and the gateway;
waking up the wireless device; and
transmitting data collected by the wireless device to the gateway via the established communication channel.

14. The method of claim 13, wherein said wireless device is an Internet-of-Things device.

15. The method of claim 13, wherein said wireless device comprises an energy harvesting circuit.

16. The method of claim 13, wherein said device comprises a battery.

17. The method of claim 15, wherein said device is not connected to an external power source.

18. The method of claim 13, wherein said device does not comprise a long-range communication module.

19. The method of claim 13, wherein said short-range communication channels operate under a short-range communication standard that is Wi-Fi, Bluetooth, or Zigbee.
